(19) United States
(12) Patent Application Publication
(10) Pub. No.: US 2004/0180595 A1
(43) Pub. Date: Sep. 16, 2004

(54) Woven brush with base for forming site seal

(76) Inventor: Matthew Arold-Gorham, Hampstead, NH (US)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/387,018

(22) Filed: Mar. 11, 2003

(51) Int. Cl. D03D 15/00; D03D 25/00; B32B 23/02

(52) U.S. Cl. 442/181; 428/192; 428/193

(57) ABSTRACT

A molded or extruded component for forming a site seal. The molded component comprising a woven brush having a plurality of warp threads and a plurality of weft threads. The warp and weft threads being woven with one another along at least one and possibly both longitudinal edges thereof, while the weft threads extending substantially normal to the longitudinal edges of the woven brush remaining unwoven. At least one of the woven longitudinal edges of the woven brush being molded with a base material to form the molded component for in forming the site seal.

### FIELD OF THE INVENTION

The present invention relates to a woven brush for providing an improved site seal for an aperture, an opening, a channel, a slot, etc.

### BACKGROUND OF THE INVENTION

Site seals are used in a variety of different applications to provide a seal for an aperture, an opening, a channel, a slot, etc. Site seals primarily form a barrier and also typically provide a decorative cover or over lay for the aperture, the opening, the channel, the slot, etc., which is to be sealed. More particularly, site seals are used in a variety of different automobile applications, such as hinge applications, stick shift applications, and the like.

A site seal typically comprises at least one synthetic brush and frequently a pair of synthetic brushes which project inwardly toward one another to form the site seal. One or more of the synthetic brushes may project inwardly at a desired angle with respect to a desired component to be sealed. Whether a single synthetic brush or a pair of synthetic brushes are utilized, the free ends of the bristles of the synthetic brush or brushes generally abut or rub against the desired component to be sealed. Due to this arrangement, the free ends of the bristles allowed the component to be adequately sealed while still allowing the component(s) to be sealed to move to and fro relative to the free ends of the bristles.

Site seals have many applications. For example, they can function as a barrier or a filter to prevent dirt, dust, debris, or other particles from passing from one side of the aperture, the opening, the channel, the slot, etc., to the opposite side of the aperture, the opening, the channel, the slot, etc. Alternatively, the site seal can be utilized merely as a seal which provides a decorative or aesthetic appearance for the end product. It is to be appreciated that there is a whole host of applications for site seals which are well known in the site seal industry.

The synthetic brush industry is constantly endeavoring to improve the seal formed by the synthetic brushes in order to provide an improved barrier for the aperture, the opening, the channel, the slot, etc., which is to be sealed. In addition, the synthetic brush industry is also constantly striving to improve the decorative appearance of the formed site seal.

### SUMMARY OF THE INVENTION

Wherefore, it is an object of the present invention to provide a woven material which is suitable for formation into a synthetic brush for use as a site seal for a variety of different applications.

Another object of the present invention is to provide a woven material which can be injection molded with a base to facilitate attachment of the woven material and later formation of a desired site seal into the final molded product.

A further object of the present invention is to provide a woven material which can be extrusion molded with a base to facilitate attachment of the woven material to a desired end product for formation of a desired site seal.

Still another object of the present invention is to provide a woven material which can be positioned within a mold, such as an injection mold, and formed integral with an injection molded component for later forming a site seal by the injection molded component.

Yet another object of the present invention is to provide a woven material which can be extrusion molded with a base component and the base component facilitates attachment of the woven material to an end product to facilitate formation of a desired site seal for the end product.

The present invention relates to a molded brush component for forming a site seal, the molded component comprising a woven brush having a plurality of warp threads and a plurality of weft threads, the warp threads and the weft threads being woven with one another along a longitudinal edge thereof such that the weft threads extending substantially normal to the at least one longitudinal edge of the woven brush; and the woven longitudinal edge of the woven brush being molded with a molded base to form the molded brush component for use in forming the site seal.

The present invention also relates to a molded brush component for forming a site seal, the molded brush component comprising a woven material having a plurality of warp threads and a plurality of weft threads, the warp threads and the weft threads being woven with one another along both longitudinal edges thereof such that the weft threads extending substantially normal to both longitudinal edges of the woven material brush; and both of the woven longitudinal edges of the woven brush being molded with a molded base to form the molded brush component for use in forming the site seal.

The present invention further relates to a method of forming a site seal with a molded brush component, the method comprising the steps of weaving a woven brush from a plurality of warp threads and a plurality of weft threads, with the warp threads and the weft threads being woven with one another along a longitudinal edge thereof such that the weft threads extend substantially normal to the at least one longitudinal edge of the woven brush; molding the woven longitudinal edge of the woven brush with a base to form the molded brush component; and using the molded brush component to form a site seal.

### BRIEF DESCRIPTION OF THE DRAWINGS

The invention will now be described, by way of example, with reference to the accompanying drawings in which:

FIG. 1 is a diagrammatic top plan view of the woven material suitable for forming the site seal according to the present invention;

FIG. 1A is a diagrammatic side elevational view of the woven material of FIG. 1;

FIG. 2 is a diagrammatic top plan view of the woven material of FIG. 1 following cutting of the woven material adjacent one longitudinal edge of the woven material to form a single synthetic brush with long bristles;

FIG. 2A is a diagrammatic top plan view of the woven material of FIG. 1 following cutting of the woven material in half to form two identical synthetic brushes;

FIG. 3 is a diagrammatic view showing one of the synthetic brushes of FIG. 2A positioned partially within an injection mold;

FIG. 3A is a diagrammatic top plan view showing the formed molded brush component of FIG. 3 following the injection molding process;

FIG. 3B is a diagrammatic end view of the injection molded product of FIG. 3A;

FIG. 3C is a diagrammatic cross sectional view showing a pair of the injection or extrusion molded products of FIG. 3A affixed to a desired component for forming a site seal for sealing a movable member;

FIG. 3D is a diagrammatic cross sectional view showing a single injection or extrusion molded product of FIG. 3A affixed to a desired component for forming a site seal for a movable member;

FIG. 4 is a diagrammatic perspective view showing one of the synthetic brushes of FIG. 2A following extrusion into a finished end product;

FIG. 4A is a diagrammatic cross-sectional view along section line 4A-4A of FIG. 4;

FIG. 4B is a diagrammatic cross sectional view showing a pair of the extrusion or molded products of FIG. 4 affixed to a desired component for forming a site seal for a movable member;

FIG. 4C is a diagrammatic cross sectional view showing a single extrusion or molded product of FIG. 4 affixed to a desired component for forming a site seal for a movable member;

FIG. 4D is a diagrammatic cross sectional view showing a pair of the extrusion or molded products of FIG. 4 located in opposed channels of a desired component for forming a site seal for a movable member;

FIG. 4E is a diagrammatic cross sectional view showing a single extrusion or molded product of FIG. 4 located in a channel of a desired component for forming a site seal for a movable member;

FIG. 5 is a diagrammatic view showing the woven material of FIG. 1 positioned within an injection mold;

FIG. 5A is a diagrammatic view showing the molded brush component following the injection molding process with the woven material;

FIG. 5B is a diagrammatic end view of the injection molded product of FIG. 5A along section line 5B-5B of FIG. 5A; and

FIG. 5C is a diagrammatic cross sectional view showing the injection molded product of FIG. 5A affixed to a desired component for forming a site seal for a movable member.

### DETAILED DESCRIPTION OF THE INVENTION

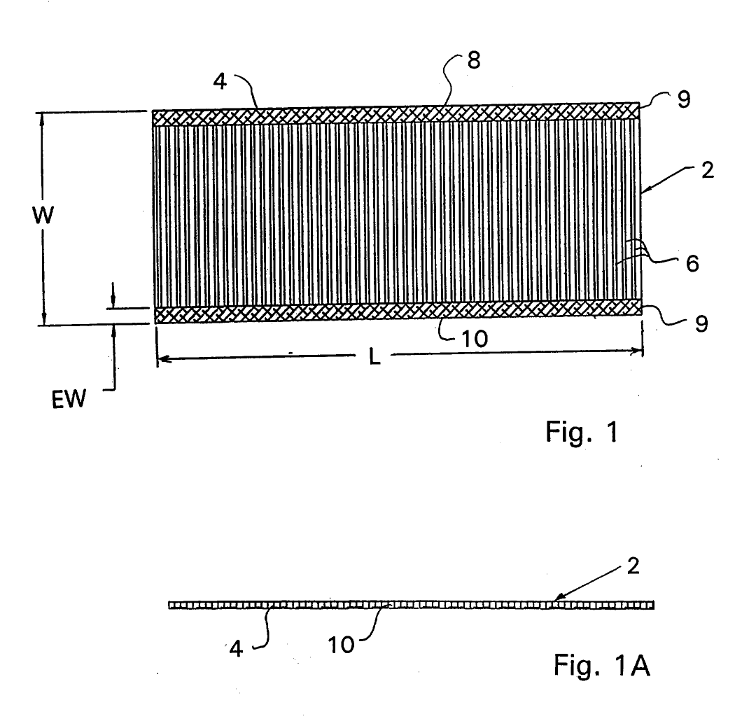

Turning now to FIGS. 1 and 1A, a detailed description concerning the woven material 2, according to the present invention, will now be provided. The woven material 2 generally comprises a plurality of warp fibers or threads 4 as well as a plurality of weft fibers or threads 6. The warp threads 4 are woven or crocheted with the weft threads 6 only along the two opposed lateral edges 8 and 10 to form the woven material 2. Typically between 2 and 24 warp threads 4, preferably between 4 and 16 warp threads, are utilized and between 2 and 100 weft threads 6, preferably between 20 and 50 weft threads, are utilized to crochet the woven material 2. Typically, the warp and weft threads, utilized for manufacturing the woven material 2, have a diameter of between 0.003 of an inch and 0.012 of an inch.

As can be seen in FIG. 1A, the warp threads 4 and the weft threads 6 are woven or crocheted with one another only along the two opposed longitudinal edges 8, 10 of the woven material 2 while the threads in the central section of the woven material 2, extending between the two longitudinal edges 8, 10 of the woven material 2, are generally grouped together in clumps of parallel strands of unwoven weft threads 6. The woven material 2 is crocheted or woven by conventional weaving equipment (not shown) in a continuous fashion to produce a continuous length of the woven material 2 which is wound around a collection spool or the like. It is to be appreciated that a variety of conventional and well known weaving or crocheting equipment can be utilized for manufacture of the woven material 2. Following manufacture of the continuous length of the woven material 2, the continuous length of the woven material is later processed, from the spool, into desired shorter lengths of the woven material 2.

Following manufacture of the woven material 2, the two opposed longitudinal edges 8, 10 of the woven material 2 are welded, fused, melted, etc., in order to affix the warp threads 4 and the weft threads 6 to one another, only along the two opposed lateral edges 8, 10, to prevent unraveling of the threads during later procession of the woven material 2. Typically, only a small elongate edge portion 9 of the longitudinal edges 8, 10, e.g., an strip having a width EW of about 1/16 to 1/8 inch or so along each longitudinal edge 8, 10, is welded, fused, melted, etc., to affixed the warp and weft threads 4, 6 in this region to one another.

A preferred method for welding the warp and the weft threads 4, 6 to one another is by ultrasonic welding. It is to be appreciated that various other conventional and well known welding, fusing, melting, etc., methods can be utilized for permanently affixing the warp threads 4 to the weft threads 6 to one another to prevent unraveling of the threads during later procession of the woven material 2, without departing from the spirit and scope of the present invention.

It is also possible for the warp threads 4 and the weft threads 6, located along the two opposed longitudinal edges 8, 10 of the woven material, to be bonded to one another by an adhesive, a glue or some other constituent (not shown) without departing from the spirit and scope of the present invention. As there are a variety of other ways, which would be apparent to those skilled in the art, to weld, fuse, melt, bond, affix, attach, etc., the warp and weft threads 4, 6 to one another to prevent unraveling thereof, a further discussion concerning the same is not provided.

The woven material 2 typically has a width dimension W of between about one-half inch or so to about six inches or so. The actual width can vary, as necessary, and the maximum width of the woven material is limited by the weaving or crocheting equipment. As previously noted, the woven material 2 is manufactured continuously and wound upon a spool for later processing into a desired lengths where the woven material 2 is subsequently trimmed, processed and/or cut to desired length dimension L of between about one-half inch or so to about twelve inches or more. The actual length of the woven material can vary, as necessary, depending upon the particular site seal application.

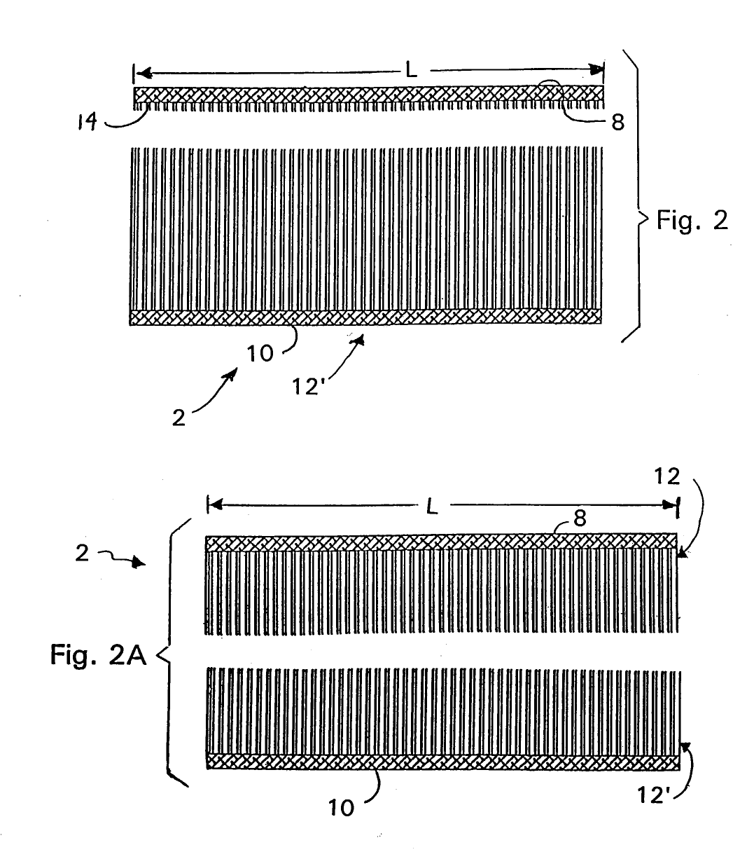

Following manufacture of the woven material 2 and processing of two opposed longitudinal edges 8, 10 of the woven material 2 to prevent unraveling thereof, the woven material 2 is then ready for processing into a desired synthetic brushing suitable for formation of a site seal and a detailed description concerning such further processing into a site seal will now be described, by way of example, with reference to FIGS. 2 and 2A.

As can be seen in FIG. 2A, the woven material 2 of FIG. 1 is first cut or processed to a desired length L and then cut in half to form two identical synthetic brushes 12, 12′ (FIG. 2A) for use in forming a site seal. It is to be appreciated that the operator can cut the woven material 2, as desired or necessary, to form either a single synthetic brush 12 (FIG. 2) or two dissimilar synthetic brushes 12, 12′ (not shown). If the woven material 2 is cut to form a single synthetic brush (FIG. 2), then the remaining material 14 is typically scrap and generally discarded. It is to be appreciated that the precise location where the woven material 2 is cut will depend upon how wide the woven material 2 is manufactured and the specific synthetic brush application.

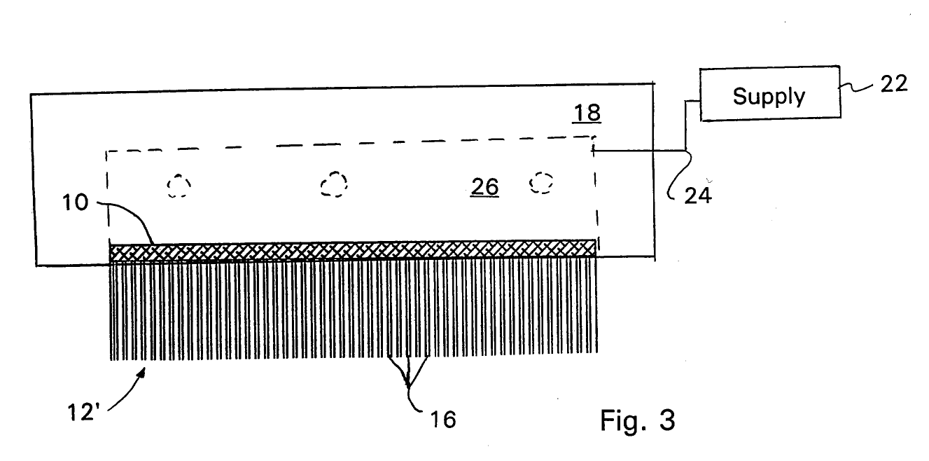

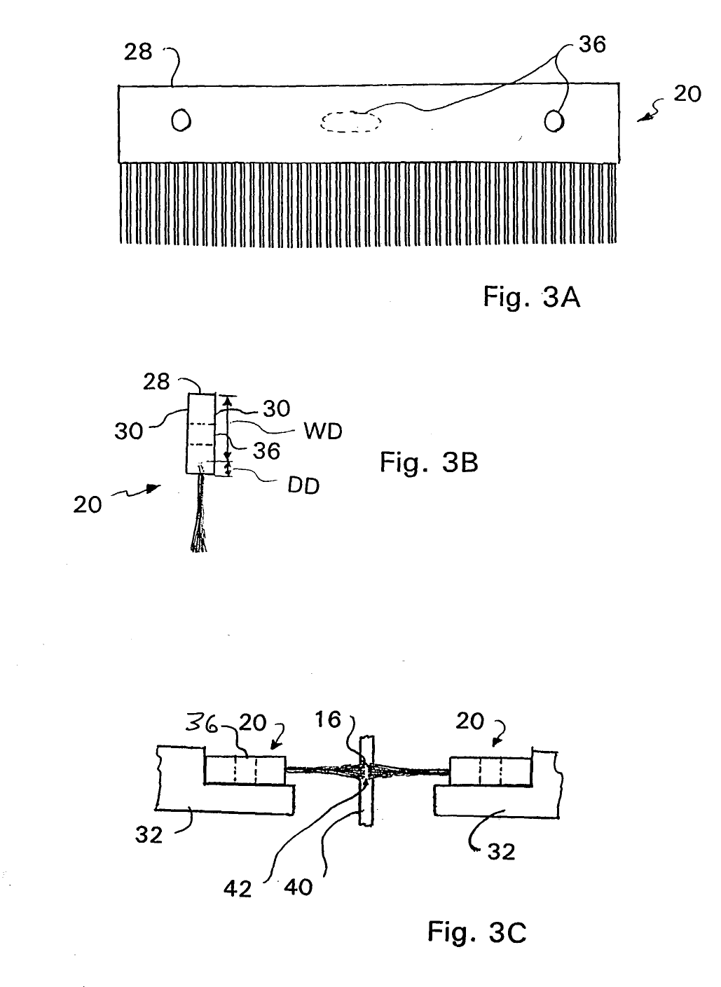

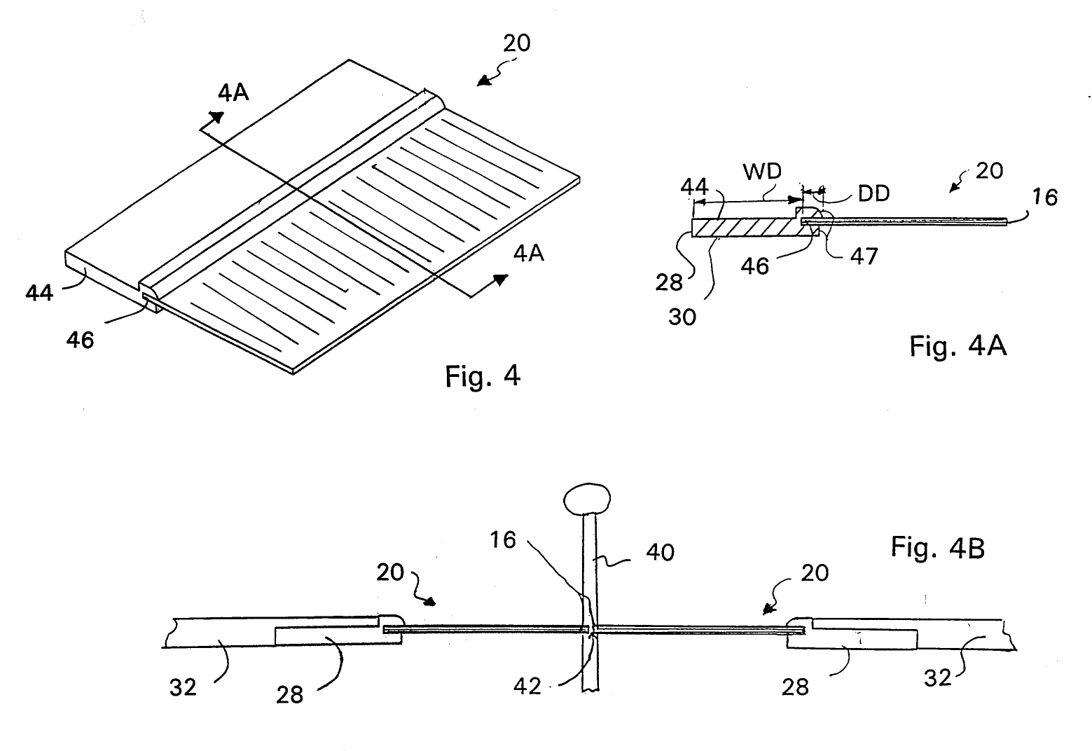

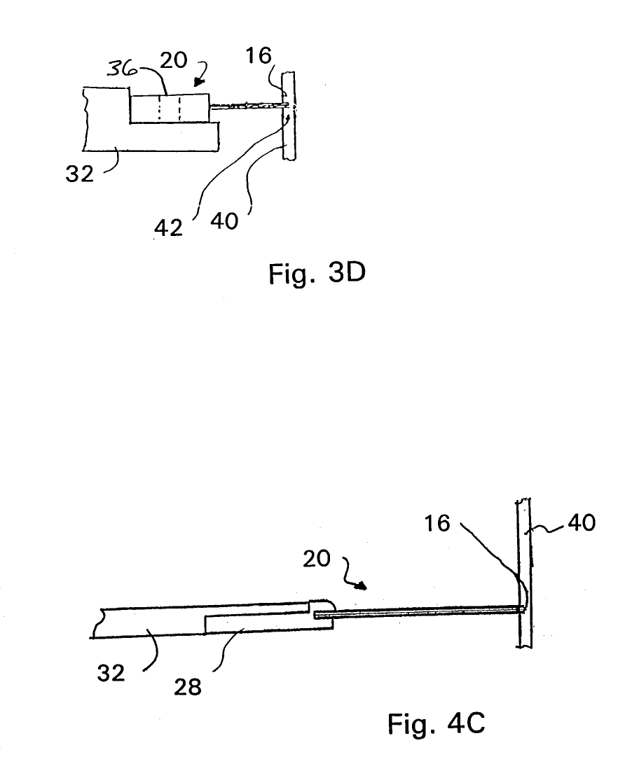

With reference now to FIGS. 3-3B, processing of a synthetic brush, e.g., one of the pair of identical synthetic brushes 12, 12′ of FIG. 2A, in to an injection molded brush product 20 will now be provided. Following processing of the woven material 2 into two identical synthetic brushes 12, 12′ (FIG. 2A), one of the two identical synthetic brushes 12′ is then placed or loaded into suitable injection molding equipment or plastic extrusion equipment such that only the woven longitudinal edge 10 of the synthetic brush 12′, or possibly only a small portion of the brushes, is generally accommodated within the mold 18 of the injection molding equipment while the remote or free ends of the bristles 16 extend outwardly away from the mold 18. The molding process is then activated so that the mold 18 is filled from a supply source 22 with a desired molten material, such as polyester, nylon, polypropylene, polystyrene, etc., and the molten material flows through a supply duct 24 and fills the entire cavity 26 of the mold 18. The molten material, as it flows into the cavity 26 surrounds, meshes with and encapsulates the woven longitudinal edge 10 of the synthetic brush 12′ accommodated by the injection molding equipment. After a sufficient amount of molten material is applied to the mold 18, the molten material is thereafter allowed to sufficiently hardened or set up. Finally, the mold 18 is opened and the injection molded brush product 20 is then removed from the mold 18.

As can be seen in FIGS. 3A and 3B, the molded brush product 20 generally comprises has a molded base 28 which with at least one generally contoured, flat or planar surface 30 which is designed to mate with a complimentary contoured, flat or planar surface of the component and facilitate attachment of the molded brush product 20 to a desired surface of a component 32 for forming a desired site seal 34 for an aperture 36, an opening, a channel, a slot, etc. Thereafter, the molded base 28 can either be glued, welded, fastened or otherwise permanently affixed, connected or attached to the desired component 32 to form the site seal 34. As such attachment is well known to those skilled in this art, a further discussion concerning attachment of the molded brush product 20 to the component is not provided. Alternatively, the molded base 28 can be injection molded with the desired component 32, in a subsequent molding process or step, to become integral with the desire component 32 to form the desired site seal 34.

As shown in FIGS. 3A and 3B, the molded base 28 can be formed with one or more attachment apertures or slots 36 to facilitate attachment of the molded brush product 20 to the desired component 32 by one or more screws, fasteners, projections, etc. As this is well known in the art, a further discussion concerning the same is not provided.

With reference to FIG. 3C, a pair of the molded brush products 20 are secured to the desired component 32 by an adhesive (not shown in detail). The free ends of the bristles 16 face toward and generally abut with one another to form a narrow opening or elongate slot 42, and the formed opening or elongate slot 42 allows relative movement of member 40 to be sealed with respect to the molded brush products 20. It is to be appreciated that the free ends of the bristles 16 may touch or overlap one another in some applications. In most applications, it is desirable, but not necessary, for each one of the molded brush products 20 to from a smooth transition with the desired surface or edge of the component 32 to be sealed to improve the aesthetic appearance of the formed site seal 34.

With reference to FIG. 3D, a single molded brush product 20 is secured to the desired component 32 by an adhesive (not shown in detail). The free ends of the bristles 16 face and generally abut with the member 40 to be sealed, e.g., a leg of a hinge. The free ends of the bristles 16 allow movement of member 40 to be sealed relative to the singe molded brush product 20. As with the previous embodiment, it is desirable, but not necessary, for the molded brush product 20 to from a smooth transition with a desired surface or edge of the desired component 32 to improve the aesthetic appearance of the formed site seal 34.

It is to be appreciated that if the longitudinal edge 8 or 10 of the woven material 2 are surrounded by, mesh intimately with and/or are encapsulated by the molten material, in some applications it may not be necessary to weld, fuse, melt or bond the warp threads 4 and the weft threads 6 together to prevent unraveling thereof. Accordingly, processing of the two opposed longitudinal edges 8, 10 of the woven material 2, to prevent unraveling of the warp and weft threads during later procession thereof, may be eliminated, if desired.

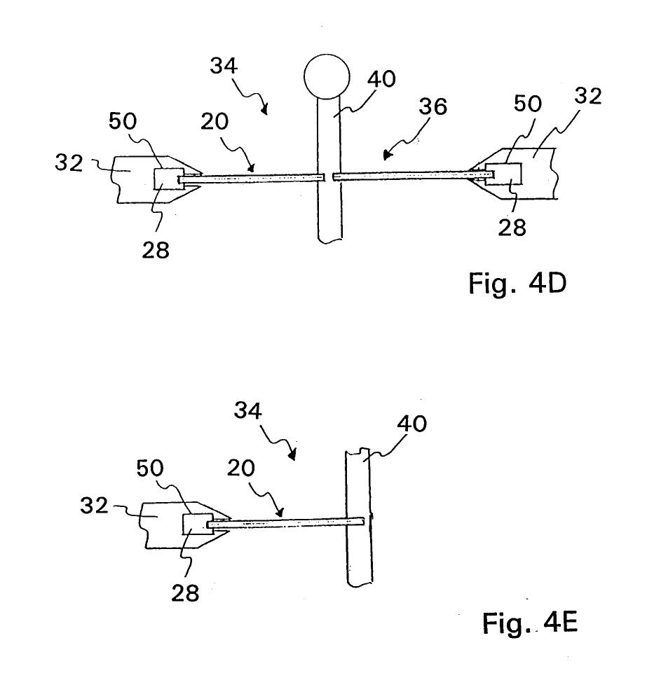

With reference now to FIGS. 4-4B, another embodiment of the present invention which relates to extrusion of the woven material 2 will now be discussed. According to this embodiment, the woven material 2 of FIG. 1, is first cut to form two separate elongate synthetic brushes 12, 12′ (FIG. 2A), a single elongate synthetic brush 12 (FIG. 2), or two dissimilar elongate synthetic brushes 12, 12′ (not shown). Thereafter, the longitudinal edge 8 or 10 of one of the elongate synthetic brush 12 or 12′ is then extruded, in a conventional manner, with an extruded material 44 to form an elongate length of the extruded brush component 20. The longitudinal edge 8 or 10 of one of the elongate synthetic brush 12 or 12′ is received within a recess 46 formed within the extruded material 44 such that the longitudinal edge 8 or 10 of one of the elongate synthetic brush 12 or 12′ becomes permanently fastened and integral with the extruded material 44 and thereby forms the extruded brush component 20. The extruded brush component 20 has a extruded molded base 28 which preferably has at least one generally contoured flat or planar surface 30 which is shaped to mate with a desired mating surface of the component 32 for forming a desired site seal 34 for an aperture 36, opening, channel, slot, etc. Finally, the extruded brush component 20 is then either affixed to a desired surface by welding, gluing, fastening or otherwise permanently affixing or attaching the base 28 of the extruded product to the desired component.

The recess 46 is defined by a pair of spaced apart legs 47 which are separated from one another by a sufficient distance to accommodate one longitudinal edge 8 or 10 of the woven material 2 therein. The base 28 typically has a width dimension WD which is at least equal to a depth dimension DD of the recess 46, more preferably the base 28 has a width dimension WD which is at least twice as large as the depth dimension DD of the recess 46 and most preferably the base 28 has a width dimension WD which is at least three times as large as the depth dimension DD of the recess 46. That is, the molded base 28, supporting the woven longitudinal edge 8 or 10 of the synthetic brush 12 or 12′, has a width which is at least equal to a width of the woven longitudinal edge 8 or 10 of the synthetic brush 12 or 12′. The depth of the recess 46 is typically between about one-eighth of an inch and about one-half of an inch, and preferably about one-quarter of an inch. The depth of the recess 46 is important in order to increase the stability of the bristles 16 of the synthetic brush 12 or 12′ once the molded base 28 is adhered, attached or otherwise fixed to the desired component 32.

With reference to FIG. 4C, an application where a single extruded brush component 20 is secured to the desired component 32 by an adhesive (not shown in detail) is depicted. The free ends of the bristles 16 face forward and generally abut with the member 40 to be sealed, e.g., a leg of a hinge. The free ends of the bristles 16 allow relative movement of member 40 to be sealed. As with the previous embodiment, it is desirable, but not necessary, for the extruded brush component 20 to from a smooth transition with a surface or edge of the desired component 32 to improve the aesthetic appearance of the formed site seal 34.

Alternatively, as shown in FIG. 4D, a desired component 32, having the an aperture 36, opening, channel, slot, etc., therein to be sealed by a desired site seal 34, can be provided with a pair of opposed channels or grooves 50 and either the extruded brush component 20 or the injection molded brush component 20 can be formed with a similarly cooperating or matingly shaped base member 28 so that a base member 28 can be intimately and captively received within each one of channels or grooves 50. The mating fit between the channels or grooves 50 and the cooperating base member 28 allows the relative sliding movement between those two components so that the extruded brush component 20 can be suitably positioned to completely over lie, cover and seal the aperture 36, opening, channel, slot, etc., of the desired component 32 and thereby form the site seal 34. Once the extruded brush component 20 or the injection molded brush component 20 is properly position to cover or seal the aperture 36, opening, channel, slot, etc., of the desired component 32, a locking plate, a member, or some other element or element (not shown) can be applied thereto to retain the installed position and thereafter prevent undesired relative sliding movement between those components.

With reference to FIG. 4E, a desired component 32, having an aperture 36, an opening, a channel, a slot, etc., therein to be sealed by a desired site seal 34, is provided with a single channel or groove 50. The extruded brush component 20 or the injection molded brush component 20 is formed with a similar cooperating or matingly shaped base member 28 so that base member 28 can be intimately received within the channel or groove 50. The mating fit between the channel or groove 50 and the cooperating base member 28 allows the relative sliding movement between those two components so that the extruded brush component 20 or the injection molded brush component 20 can be suitably positioned to completely cover and seal the aperture 36, opening, channel, slot, etc., in the desired component 32 and thereby form the site seal 34. Once the extruded brush component 20 or the injection molded brush component 20 is properly position to cover or seal the aperture 36, opening, channel, slot, etc., of the desired component 32, a locking plate, a member, or some other element or element (not shown) can be applied to retain the install position and thereafter prevent undesired relative sliding movement between those components.

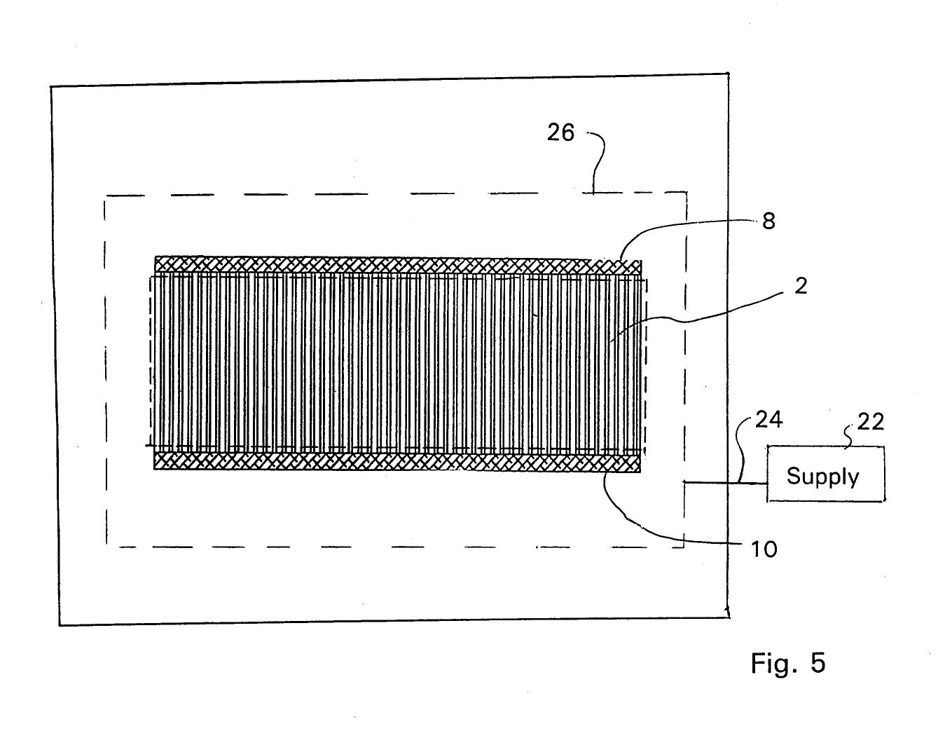

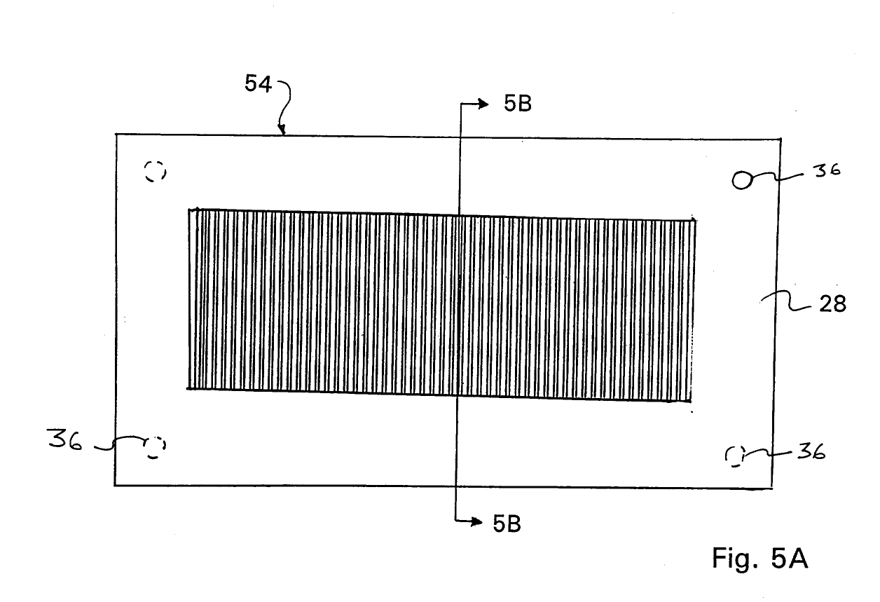

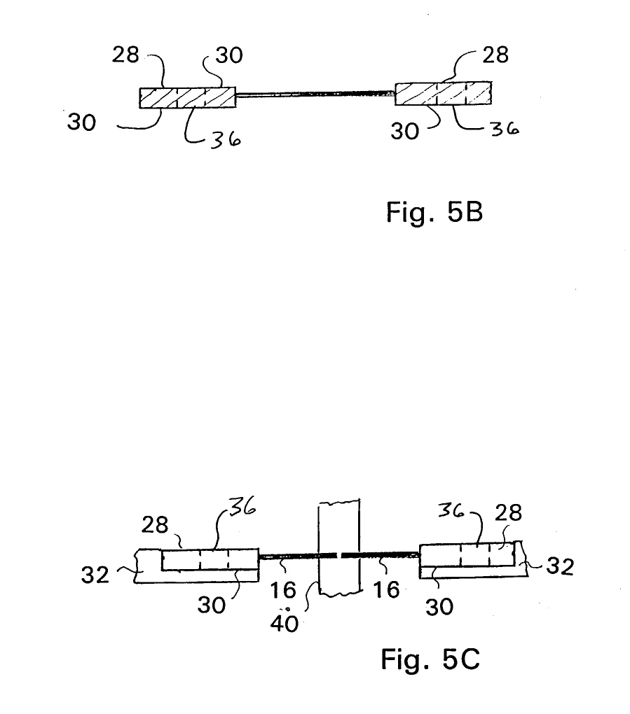

With reference now to FIGS. 5-5C, processing of a woven material 2 into an injection molded site seal product 52 will now be provided. The woven material 2, following manufacture, is placed or loaded into a mold 18 of suitable injection molding equipment. The molding process is then activated so that the mold 18 is filled from a supply source 22 with a desired molten material, such as polyester, nylon, polypropylene, polystyrene, etc., and the molten material flows through a supply duct 24 and fills the entire cavity 26 of the mold 18, except for the central region of the woven material 2. The molten material surrounds, meshes with and encapsulates both longitudinal edges 8, 10 and both transverse edges of the woven material 2 accommodated by the injection molding equipment. After a sufficient amount of molten material is applied to the mold 18, the molten material is allowed to sufficiently hardened or set up. Next, the mold 18 is opened and the injection molded woven product 54 is then removed from the mold 18.

As can be seen in FIGS. 5A and 5B, the molded woven product 54 has a molded base 28 with at least one generally contoured, flat or planar surface 30 which is shaped to mate with and facilitate attachment of the molded woven product 54 to a desired surface of a component 32 for forming a desired site seal 34 for the aperture, opening, channel, slot, etc. It is to be appreciated that the molded base 28 can be either captively retained or glued, welded, fastened or otherwise permanently affixed, connected or attached to a desired component 32 to form the site seal 34. As such teaching is well known to those skilled in this art, a further discussion concerning the same is not provided.

As shown in FIGS. 5A and 5B, the molded base 28 can be formed with one or more attachment apertures or slots 36 to facilitate attachment of the injection molded woven product 54 to the desired component 32 by one or more screws, fasteners, projections, etc.

Following manufacture of the injection molded woven product 54, the woven material 2 is typically subjected to a slitting or cutting operation. During the slitting or cutting operation, the weft threads 6 of the woven material 2 are cut or slit into a desired elongate slit or slot, one or more holes, grooves, or any other desired shaped opening in order to complete manufacture of the injection molded woven product 54. The desired elongate slit, or slot, one or more holes, grooves, or any other desired shape or configuration in order to complete manufacture of the injection molded woven product 54. As with the previous embodiments, the free ends 16 of the bristles to provide their sealing function for the sealed member 40 without unduly hindering movement thereof. The sealed member 40 may be, for example, a hinge, a stick shift, etc., which extends through and engages with the desired elongate slit, or slot, one or more holes, grooves, or any other desired shape or configuration formed in the weft threads 6 and is permitted to move relative thereto.

As the two opposed longitudinal edges 8, 10 of the woven material 2 are both surrounded by, mesh intimately with and/or are encapsulated by the molten material, it may not be necessary to weld, fuse, melt or bond the warp threads 4 and the weft threads 6 together, for some applications, to prevent unraveling thereof. Accordingly, processing of the two opposed longitudinal edges 8, 10 of the woven material 2, to prevent unraveling of the warp and weft threads during later procession of the woven material 2, may be eliminated.

It is to be appreciated that the molded base 28 is securely attached to the bristles of the synthetic brushes 12, 12′ so that the bristles extend generally normal to the molded base 28 and the bristles retain their initial molded position even over a prolonged period of usage.

Since certain changes may be made in the above described improved woven material for forming a site seal, without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore, I/we claim:

1. A molded or extruded brush component for forming a site seal, the molded component comprising:
a woven brush having a plurality of warp threads and a plurality of weft threads, the warp threads and the weft threads being woven with one another along a longitudinal edge thereof such that the weft threads extending substantially normal to the at least one longitudinal edge of the woven brush; and
the woven longitudinal edge of the woven brush being molded with a molded base to form the molded brush component for use in forming the site seal.

2. The molded or extruded brush component of claim 1, wherein the molded base has at least one alignment member for facilitating attachment of the molded brush component to a desired component for forming the site seal.

3. The molded or extruded brush component of claim 1, wherein the molded base has at least one surface which is designed to mate with a complimentary surface of the component and facilitate attachment of the molded brush product to the surface of the component for forming the site seal.

4. The molded or extruded brush component of claim 1, wherein the woven brush has between 20 to 50 weft threads and between 2 to 16 warp threads, and both the warp threads and the weft threads each have a diameter of between 0.003 of an inch and 0.012 of an inch.

5. The molded or extruded brush component according to claim 1, wherein the molded base, supporting the woven longitudinal edge of the synthetic brush, has a pair of legs which define a recess therebetween, and the molded base has a width dimension which is at least equal to a depth dimension of the recess.

6. The molded or extruded brush component according to claim 1, wherein the molded base is manufactured from a material selected from the group comprising polyester, nylon, polypropylene, styrene and a synthetic material.

7. The molded or extruded brush component according to claim 1, wherein the molded base, supporting the woven longitudinal edge of the synthetic brush, is flexible to allow the molded brush component to follow a contour of a surface to which the molded component is to be attached for forming the site seal.

8. The molded or extruded brush component according to claim 1, wherein the molded base, supporting the woven longitudinal edge of the synthetic brush, has a width which is at least equal to a width of the woven longitudinal edge of the synthetic brush.

9. The molded or extruded brush component according to claim 1, wherein the molded base, supporting the woven longitudinal edge of the synthetic brush, has an exposed surface which provides a smooth transition between bristles of the synthetic brush and the exposed surface of the component to be sealed to provide an aesthetic appearance for the formed site seal.

10. The molded or extruded brush component according to claim 1, wherein both opposed longitudinal edges of the woven material are welded to affix the warp threads to the weft threads adjacent the longitudinal edges of the woven material and minimize unraveling of the woven material.

11. A molded or extruded brush component for forming a site seal, the molded brush component comprising:
a woven material having a plurality of warp threads and a plurality of weft threads, the warp threads and the weft threads being woven with one another along both longitudinal edges thereof such that the weft threads extending substantially normal to both longitudinal edges of the woven material brush; and
both of the woven longitudinal edges of the woven brush being molded with a molded base to form the molded brush component for use in forming the site seal.

12. The molded or extruded brush component of claim 11, wherein the molded base has at least one alignment member for facilitating attachment of the molded brush component to a desired component for forming the site seal.

13. The molded or extruded brush component of claim 11, wherein the molded base has at least one surface which is designed to mate with a complimentary surface of the component and facilitate attachment of the molded brush product to the surface of the component for forming the site seal.

14. The molded or extruded brush component of claim 11, wherein the woven brush has between 20 to 50 weft threads and between 2 to 16 warp threads, and both the warp threads and the weft threads each have a diameter of between 0.003 of an inch and 0.012 of an inch.

15. The molded or extruded brush component according to claim 11, wherein the molded base, supporting both of the woven longitudinal edges of the synthetic brush, has a width which is at least equal to a width of the woven longitudinal edge of the synthetic brush.

16. The molded or extruded brush component according to claim 11, wherein the molded base is manufactured from a material selected from the group comprising polyester, nylon, polypropylene and styrene.

17. The molded or extruded brush component according to claim 11, wherein the molded base, supporting the woven longitudinal edge of the synthetic brush, is flexible to allow the molded brush component to follow a contour of a surface to which the molded component is to be attached for forming the site seal.

18. The molded or extruded brush component according to claim 11, wherein the molded base, supporting the woven longitudinal edge of the synthetic brush, has an exposed surface which provides a smooth transition between bristles of the synthetic brush and the exposed surface of the component to be sealed to provide an aesthetic appearance for the formed site seal.

19. The molded or extruded brush component according to claim 11, wherein the woven material is further processed by cutting the plurality of weft threads to form at least one of a slit, a slot, a hole, a groove, a shaped opening in the woven material prior to forming the site seal.

20. A method of forming a site seal with a molded or extruded brush component, the method comprising the steps of:
weaving a woven brush from a plurality of warp threads and a plurality of weft threads, with the warp threads and the weft threads being woven with one another along a longitudinal edge thereof such that the weft threads extending substantially normal to the at least one longitudinal edge of the woven brush;
molding the woven longitudinal edge of the woven brush with a base to form the molded brush component; and
using the molded brush component to form a site seal.
